(19) United States
(12) Patent Application Publication
(10) Pub. No.: US 2012/0226585 A1
(43) Pub. Date: Sep. 6, 2012

(54) Method and Apparatus for Dynamic Online Pricing

(75) Inventors: Ruslan Kogan, Melbourne (AU); David Shafer, Caulfield (AU); Goran Stefkovski, Hampton (AU)

(73) Assignee: Kogan Technologies Pty Ltd, Albert Park (AU)

(21) Appl. No.: 13/283,576

(22) Filed: Oct. 28, 2011

(30) Foreign Application Priority Data
Mar. 1, 2011 (AU) 2011900708

(51) Int. Cl. G06Q 30/06

(52) U.S. Cl. 705/26.61

(57) ABSTRACT

A method and apparatus for presenting a dynamic pricing of a commodity to a prospective client. The apparatus comprising: a server module coupleable to a database that includes data indicative of pricing parameters for calculating the dynamic pricing; the server module being coupleable by a data network to a remote interface element for presenting the dynamic pricing to the prospective client. The apparatus being adapted to: receive pricing parameters for calculating the dynamic pricing; compute the dynamic pricing according to a predetermined pricing function using the pricing parameters; and present an instant of the dynamic pricing to the prospective client.

### FIELD OF THE INVENTION

The present invention relates to retail apparatus and methods, and in particular to online retail apparatus and methods.

The invention has been developed primarily for use as an apparatus and method for providing an online dynamic price for goods and services and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known methods for providing online pricing includes advertising status retail or sale prices. Sale prices are typically used to encourage customers and/or to assist in clearing older stock. It would be appreciated that these prices provide a single reference for a customer to consider, in relation to other competing products and/or services.

There is a need in the art for a method of assigning a dynamic online price to that item for encouraging a customer to purchase.

### OBJECT OF THE INVENTION

It is an object of the present invention to overcome or ameliorate at least one of the disadvantages of the prior art, or to provide a useful alternative.

It is an object of the invention in its preferred form to provide an apparatus, or method, for providing a dynamic online price for a commodity.

### SUMMARY OF THE INVENTION

According to an aspect of the invention there is provided an apparatus for presenting a dynamic pricing of a commodity to a prospective client (or customer), the apparatus being adapted to:
(a) receive pricing parameters for calculating the dynamic pricing;
(b) compute the dynamic pricing according to a predetermined pricing function using the pricing parameters; and
(c) present an instant of the dynamic pricing to the prospective client.

According to an aspect of the invention there is provided a method of providing a dynamic pricing for a commodity, the method comprising the steps of:
(a) receiving pricing parameters for calculating the dynamic pricing;
(b) computing the dynamic pricing according to a predetermined pricing function using the pricing parameters; and
(c) presenting an instant of the dynamic pricing.

Preferably the dynamic pricing is calculated in substantially real-time using current pricing parameters. More preferably, the presented dynamic pricing is repeatedly updated. Most preferably, the presented dynamic pricing is repeatedly updated on a periodic basis using real-time prising parameters.

Preferably, a user interface presents the dynamic pricing to the prospective client. More preferably, the prospective client can agree to purchase the commodity for the price indicated by the presented dynamic pricing. Most preferably, the user interface enable the prospective client to attend to payment of the commodity for the price indicated by the presented dynamic pricing.

Preferably, the commodity is offered for sale prior to availability. More preferably, the pricing function increases from start price at commencement of dynamic pricing to a finish price being a final retail price about the time when the commodity becomes available.

Preferably, the pricing function is a function of time periods (time units or parts thereof). More preferably, the pricing function is monotonically non-decreasing as a function of the time units. Most preferably, the function is monotonically increasing as a function of the time units.

Preferably, the pricing function is updated over time periods (time units or parts thereof). The pricing function is preferably monotonically non-decreasing or monotonically increasing as a function of the time units. Alternately, the function can decrease as a function of the time units. More preferably, the pricing function includes a stock counter module term.

Preferably, the pricing parameters include parameters indicative of the manufacturing status (or state), availability status (or state) or pre-sold status (or state). More preferably, the pricing parameters can further include predetermined (constant) parameters. Most preferably, the pricing parameters include any one or more of the following: duration of dynamic pricing in time units; start price at commencement of dynamic pricing; finish price being a final retail price at the conclusion of dynamic pricing; duration of live pricing in time periods; number of units in a batch; number of units currently sold from the batch; and rate of sales.

Preferably, the pricing function is a linear function. More preferably, the pricing function is a piecewise linear function. Most preferably, the piecewise linear pricing function is further determined on the basis of one or more of the following terms: time state; number of units remaining for sale; number of units in a batch; and rate of sales.

Preferably, the pricing function is a non-linear function. More preferably, the pricing function is a piecewise non-linear function. Most preferably, the piecewise non-linear pricing function is determined on the basis of one or more of the following terms manufacturing state; time state; number of units remaining for sale; number of units in a batch; and rate of sales.

Preferably, the pricing function is a parameterised function. More preferably, the parameterised pricing function is parameterised using parameters indicative of one or more terms including: manufacturing state number of units remaining for sale; number of units in a batch. Most preferably, the parameterised pricing function is a non-decreasing function over time units.

Preferably, the pricing function can define a decreasing price function. More preferably, the decreasing price function over time can be used for clearance stock. Most preferably, decreasing price function can include a term indicative of units remaining or stock availability, with stock counter typically indicating the number of remaining units.

Preferably, updated pricing parameters are received, and an updated dynamic pricing can be computed and presented. More preferably, the updated dynamic pricing can be periodically computed and presented. Most preferably, the presented dynamic pricing is automatically updated at predetermined time intervals or continuously updated.

Preferably, the updated dynamic pricing can be periodically computed and presented. More preferably, the presented dynamic pricing includes fractions of currency units. Most preferably, the presented dynamic pricing is automatically updated at regular predetermined time intervals.

Preferably, method steps (a) through (c) are repeated for updating dynamic pricing.

According to an aspect of the invention there is provided an apparatus for providing a dynamic pricing for a commodity, the apparatus comprises:
a processor element coupleable to a database, the database including data indicative of pricing parameters for calculating the dynamic pricing;
the processor element adapted to compute the dynamic pricing according to a predetermined pricing function using the pricing parameters; and
the processor element being coupled to an interface element adapted to retrieve and present the dynamic pricing.

Preferably, the dynamic pricing is presented through a data communication network. More preferably, the dynamic pricing is presented through a web interface. Most preferably, the dynamic pricing is an online dynamic pricing presented through an internet web interface.

Preferably, the dynamic pricing is communicated through a data communication network to a user interface for presenting the dynamic pricing to a prospective client. More preferably the commodity is a good or service for sale to a prospective customer.

Most preferably, the prospective client can initiate purchase of a commodity subject of the dynamic pricing before retail availability.

According to an aspect of the invention there is provided a user interface for a processor device, the processor device being adapted to enable a method directed at presenting one or more instances of the dynamic pricing to a user, the processor device being coupleable to a pricing server; the interface comprising a control program adapted to:
present the dynamic pricing for each of one or more commodity;
update the dynamic pricing.

Preferably, the user interface is adapted to enable prospective client to initiate purchase of a commodity subject of the dynamic pricing before retail availability.

Preferably, the dynamic pricing is associated with a commodity for sale to a prospective client. More preferably the dynamic pricing is associated with a commodity, being a good or a service, priority to availability. Alternatively a dynamic prising the dynamic pricing is associated with a commodity, being a good or a service, while in stock or available. Preferably, the user interface is a web interface. More preferably, the user interface is a mobile web interface.

Preferably, the user interface is adapted to periodically update presented dynamic pricing for each of one or more commodities.

According to a further aspect of the invention there is provided a computer program product stored on a computer usable medium, the computer program product adapted to provide a method of providing a dynamic pricing for a commodity as herein described.

According to a further aspect of the invention there is provided a computer readable medium for operation with a processor device, the computer readable medium comprising computer code for executing a method of providing a dynamic pricing for a commodity as herein described.

According to a further aspect of the invention there is provided a computer program product stored on a computer usable medium, the computer program product adapted to provide a user access interface for a computer device, the computer device being adapted to receive data indicative of one or more manufacturing states, the computer device being coupleable to database having one or more records indicative of pricing parameters; the computer program product comprising:
computer readable program means for calculating a dynamic pricing for a commodity.

### BRIEF DESCRIPTION OF THE DRAWINGS

A preferred embodiment of the invention will now be described, by way of example only, with reference to the accompanying drawings in which:

FIG. 1A is a schematic view of an embodiment apparatus according to the invention;

FIG. 1B is a schematic view of the apparatus of FIG. 1A, show with additional server devices;

FIG. 2 is a flow chart of a method according to the invention;

FIG. 3 is a flow chart of a method according to the invention;

FIG. 4 is a screen shot of a dynamic price instance according to the invention;

FIG. 5 is a screen shot of a user interface according to the invention, shown with a plurality of dynamic price instances;

FIG. 6A is a graph view of a linear dynamic price function according to the invention;

FIG. 6B is a graph view of a piecewise linear dynamic price function according to the invention;

FIG. 7A is a graph view of a non-linear dynamic price function according to the invention;

FIG. 7B is a graph view of a piecewise non-linear dynamic price function according to the invention;

FIG. 8 is a graph view of an embodiment dynamic price function according to the invention; and

FIG. 9 is a graph view of an embodiment dynamic price function according to the invention;

FIG. 10 is a graph view of an embodiment dynamic price function according to the invention, shown with a decreasing cost over time; and

FIG. 11 is a screen shot of a dynamic price instance according to the invention.

### PREFERRED EMBODIMENT OF THE INVENTION

It will be appreciated that production of new commodities (such as retail products) commences well before they are readily available to retail or dispatched to customers. Similarly, it is beneficial to provide for pricing of services at a later point in time (for example, pay now for entitlement to services later to avoid a price rise. For products that have a relatively short life cycle, it is particularly beneficial to have early commitment of sales from customers.

A retailer can enable benefits by providing customers an opportunity to join retailers early in the manufacturing cycle, where they may access benefits such as lower prices for the latest products. This has even greater benefit for retailers that are also responsible for wholesaling and importing (possibly specifying and manufacturing) products.

A service provider can enable benefits by providing customers an opportunity to pre-purchase an entitlement to services at a later point in time, where they may access benefits such as lower prices or guaranteed service entitlements.

By seeking/providing an early commitment, customers can trade waiting time for products (particularly when provided straight off the assembly line) or services to obtaining a lower price. This lower price can be calculated and may be dependant on, other parameters including any one or more the following: the time remaining to retail availability; or the number products to be available; or entitlements remaining from the total number offered—at which time the price may revert to a recommended retail price.

A dynamic pricing, or LivePrice, enables a prospective customer to purchase a product while it is in the process of manufacturing or shipping, or a clearance product, or an entitlement to services prior to the commencement of the entitlement period. In an embodiment, the price of the product or service can gradually increase at a rate that depends on a number of factors, including: until a number of products or entitlements remaining in an offering; reaching an expected dispatch date or service provision date; or reaching a retail value price. Customers who commit early can receive a better price or an entitlement.

It will be appreciated that, a product or service is typically pre-purchased (prior to availability), a customer may rescind a purchase agreement, and request a refund. The product can then be added back to the pool of available batch products. For example, a refund may be available at any time the product is subject to dynamic pricing.

By enabling customers the opportunity to join retailers early in a manufacturing cycle or prior to the entitlement period for services, the retailer can further reduce the price of latest products or services offered.

It will be appreciated that, a product is typically reducing in value as it ages in a retailer's or wholesaler's storage. By enabling customers the opportunity to take advantage of a reduction in price, dependent on the time a product (which is in stock) is offered for sale, the retailer or wholesaler can further reduce the price of clearance products offered, while still preserving the impetus for a customer to buy the product due to the possibility that the stock will sell out.

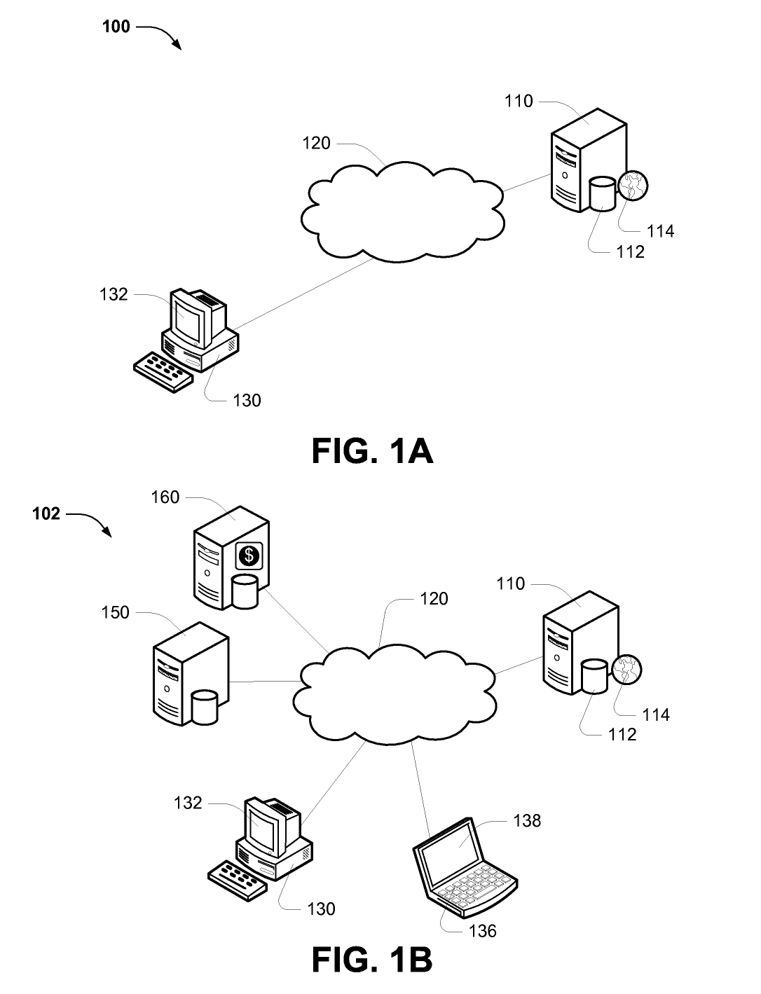

FIG. 1A shows, an apparatus 100 for providing a dynamic pricing for a commodity. The apparatus comprises:
a processor element (or server module) 110 coupleable to a database 112, the database including data indicative of pricing parameters for calculating the dynamic pricing;
the processor element adapted to compute the dynamic pricing according to a predetermined pricing function using the pricing parameters;
an interface server 114 operatively associated with the processor element 110;
the processor element being coupleable by a data network 120 to an interface element 130 adapted to retrieve and present the dynamic pricing.

In this embodiment, the interface element 130 is adapted to receive dynamic pricing for each of one or more commodities, wherein each of the dynamic pricing is presented on a user interface 132. The interface element enables the user to selectively enter a purchase agreement, at a dynamic pricing, prior to availability of the respective commodity. Payment is typically made immediately upon settlement of the purchase agreement.

Referring to FIG. 1B, an embodiment apparatus can further include:
a product server 150 for maintaining or updating data parameters relevant to a commodity.
a financial server 160 for enabling funds transfer upon a customer making a purchase agreement.

It will be appreciated that a dynamic online pricing can be presented to a plurality of simultaneous prospective customers (130, 136) via respective user interfaces (132, 138), wherein the present live price can be maintained and/or updated periodically.

In an embodiment, a product server device can be adapted to monitor the status of a product in manufacture and/or control or maintain a state machine indicative of that product status, for determining a dynamic pricing based on the status of the product and time to estimated availability. A user interface can be provided, typically via a web publication, presenting the dynamic online pricing for the respective product. The online pricing is updated periodically, for example, every few seconds, to convey the price increase over time to a potential customer. The customer can select to purchase a product in advance of availability, and based on the current dynamic online pricing. Payment is typically made at or soon after selecting to purchase the product at the dynamic price.

By way of example, the dynamic pricing is presented through an internet data communication network via a web interface. The dynamic pricing is communicated through the data communication network to a user interface for presenting the dynamic pricing to a prospective client. The commodity typically being a good for sale or a service to a prospective customer. The prospective client can initiate purchase of a commodity subject of the dynamic pricing before retail or during availability.

In an embodiment, by way of example only, an apparatus can present a dynamic pricing of a commodity to a prospective client (or customer). The apparatus being adapted to:
(a) receive pricing parameters for calculating the dynamic pricing
(b) compute the dynamic pricing according to a predetermined pricing function using the pricing parameters; and
(c) present an instant of the dynamic pricing to the prospective client.

In this embodiment, the dynamic pricing is calculated in substantially real-time using current pricing parameters, and can be repeatedly updated. Typically, the presented dynamic pricing is repeatedly updated on a periodic basis using real-time prising parameters.

It will be appreciated that a user interface can present the dynamic pricing to the prospective client. The prospective client can agree to purchase the commodity for the price indicated by the presented dynamic pricing, wherein the user interface enables the prospective client to attend to payment of the commodity for the price indicated by the currently presented dynamic pricing.

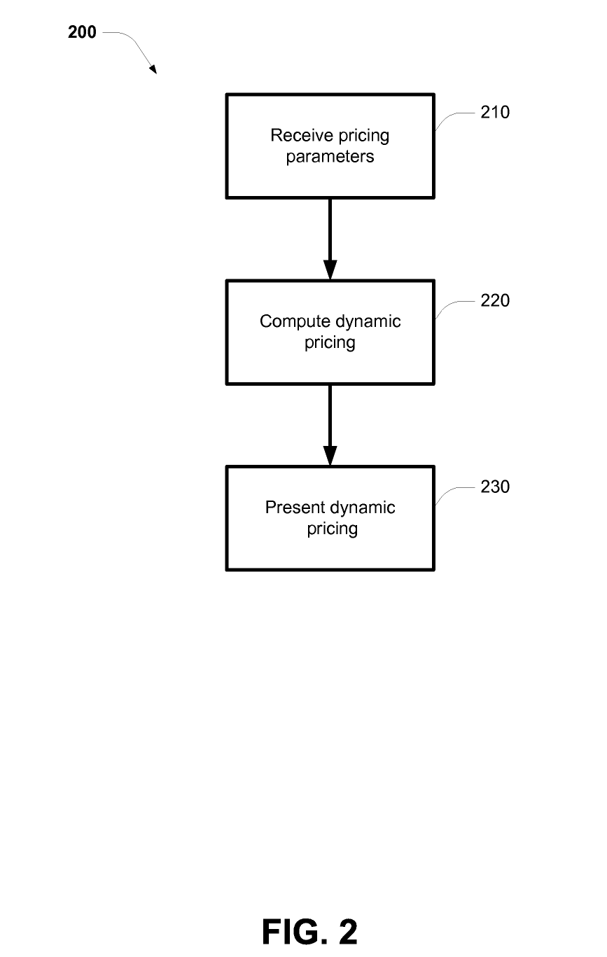

FIG. 2 shows a flowchart 200 for an embodiment method of providing a dynamic pricing for a commodity. The method 200 comprises the steps of:
STEP 210: receiving pricing parameters for calculating the dynamic pricing;
STEP 220: computing the dynamic pricing according to a predetermined pricing function using the pricing parameters; and
STEP 230: presenting an instant of the dynamic pricing.

Typically, method STEP 210 through STEP 230 are repeated for updating dynamic pricing. In an embodiment, updated pricing parameters are periodically received or requested, and an updated dynamic pricing can be computed and periodically presented, being typically automatically updated at predetermined time intervals, or presented when demanded by client interface systems.

An embodiment pricing function can be a function of time periods (time units or parts thereof), which is monotonically non-decreasing or monotonically increasing. It will be appreciated that the rate of change of the pricing function need not be uniform and can be an algorithm defined variable.

By way of example, the pricing parameters include parameters indicative of the time status prior to availability (or state), availability status (or state) or pre-sold status (or state). The pricing parameters can further include predetermined (constant) parameters. In an embodiment, the pricing parameters can include any one or more of the following: duration of dynamic pricing in time units; start price at commencement of dynamic pricing; finish price being a final retail price at the conclusion of dynamic pricing; duration of live pricing in time periods; number of units in a batch; and number of units currently sold from the batch.

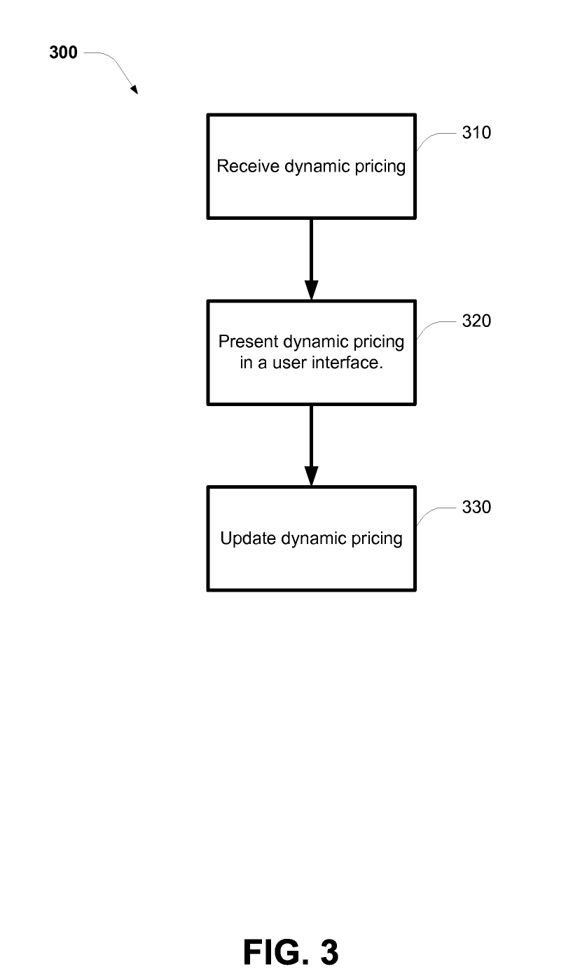

FIG. 3 shows a flowchart 300 for an embodiment method of presenting a dynamic pricing for a commodity. The method 300 comprises the steps of:
STEP 310: receiving dynamic pricing for one or more commodity, wherein each dynamic pricing is computed according to a predetermined pricing function using pricing parameters;
STEP 320: presenting, in a user interface, an instant of the dynamic pricing for each respective commodity;
STEP 330: updating each instance of the dynamic pricing.

In an embodiment a user interface is presented to a potential customer, in which a dynamic online pricing for a commodity is updated on a periodic basis (for example, every few seconds) to indicate an increase in price over time. The increase of price is based on a pricing function. The appearance of increasing price can entice the customer to select to buy a product prior to availability, thereby securing a price lower than a recommended retail price (or typical sale price).

A dynamic online pricing for a commodity (or product) can be presented to a potential customer through a user interface. The dynamic online pricing is typically presented via a web browser user interface. An application can be adapted to calculate a dynamic online price, and present the dynamic online pricing to a user interface.

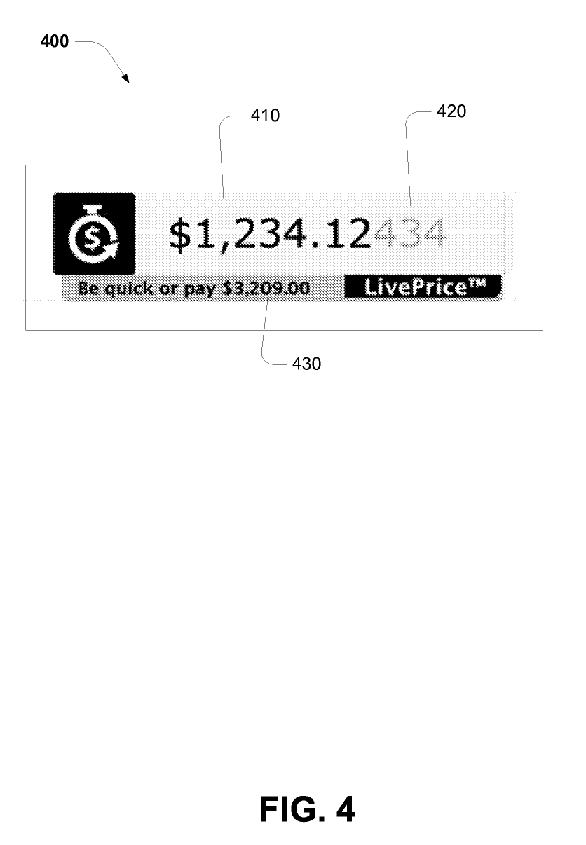

Referring to FIG. 4, a presented dynamic pricing can be in the form 400. In this embodiment a dynamic price 410 is shown with additional fractional currency units 420. It will be appreciated that these additional fractional currency units display a greater relative level of change (or increase), when compared to more significant digits in the price, which may better convey or highlight increases in purchase price over time. A retail price 430 may also be displayed to further highlight available savings in purchase price.

The price presented to the potential customer, can include place values indicative of fractional currency units, which are rounded to the nearest currency unit at the time of purchase. It would be appreciated that the additional place values provide an appearance that the prices are dynamic over time. The respective pricing function is preferably a monotonic increasing function, or monotonic non-decreasing function. However, the pricing function can be defined to decrease, for example when selling clearance items—provided that limited stock is remaining and preferably stated.

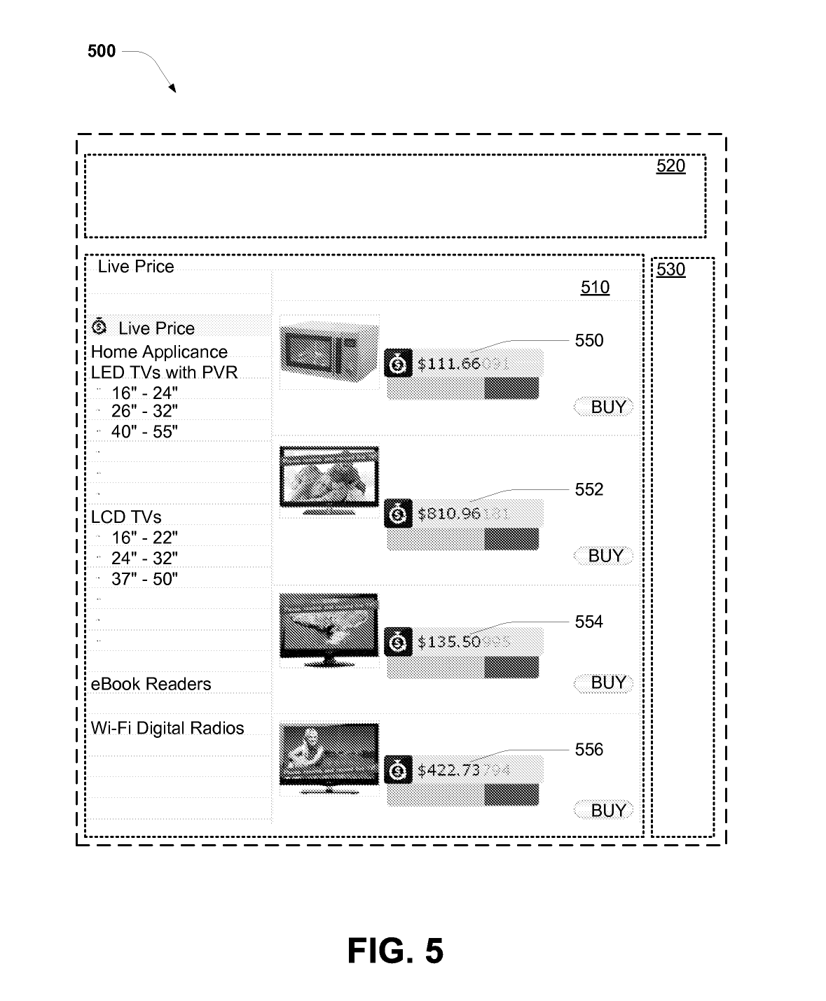

FIG. 5 shows an embodiment user interface 500, wherein a region 510 presents a dynamic pricing for a plurality of commodities (550, 552, 554, 556, 558). Each dynamic pricing is updated on a regular basis. The user interface can further comprise other regions for presenting retailer information 520 and other advertising 530.

The dynamic pricing can be based on a function and/or states machine.

By way of example; the price may be subject to a linear function commencing from a starting price at a first time and finishing at the recommended retail price at a time estimated for availability of the product. Alternatively, a logistical based model can be provided wherein the price increases based on the status of the timing between commencement of listing and arrival of the commodity in store, and the number of commodities in the batch remaining as a percentage of the total quantity initially available in the batch. In this example, the price may be calculated on the basis of a plurality of linear or non-linear curves or functions (a polygonal chain) that provide a single valued function over time.

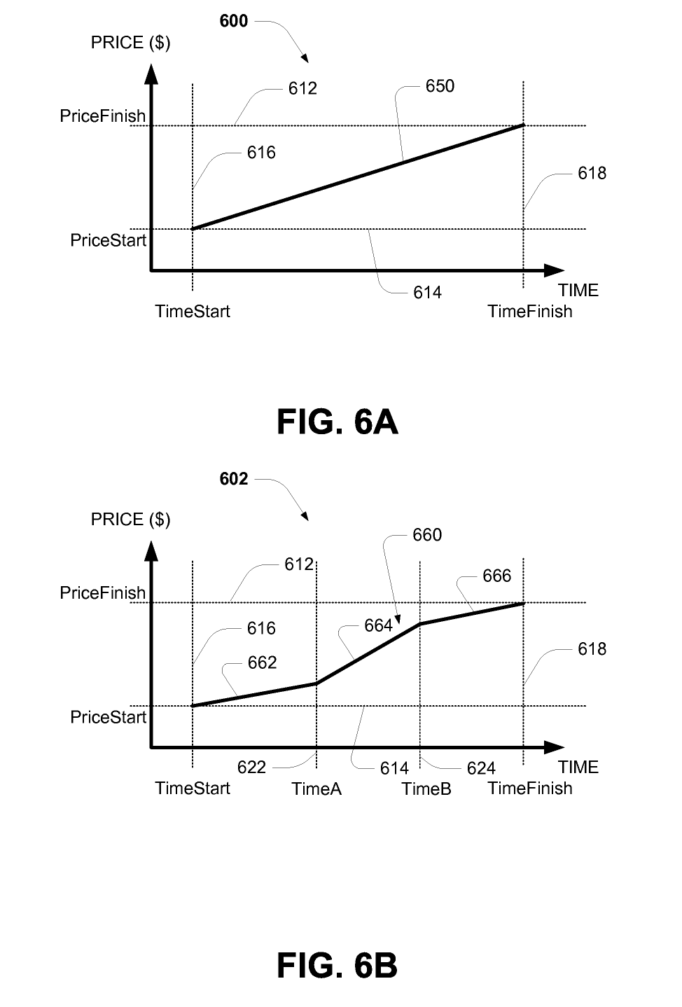

FIG. 6A shows an example pricing function 600. A finish price 612 typically being a recommended retail price, and a start price 614 typically being a predetermined percentage of the final price, or a predetermined percentage of cost price. A start time 616 can be normalised to zero, and a finish time 618 can be set as the estimated availability of the product. In this example, the pricing function is a linear function 650 commencing from a start price at a start time and extending through to the finish price (recommended retail price) at the finish time (estimated availability of the product).

FIG. 6B shows an example pricing function 602. In this example, the pricing function is a piecewise linear function 660, with linear segments (662, 664, 666) defined between start time 616, Time-A 622 Time-B 624 and finish time 618. It will be appreciated that the pricing function commences from a start price at a start time and extending through to the finish price (recommended retail price) at the finish time (estimated availability of the product). By way of example, the location of Time-A and Time-B can be predetermined, a result of a manufacturing state or milestone, or a result of a sale milestone.

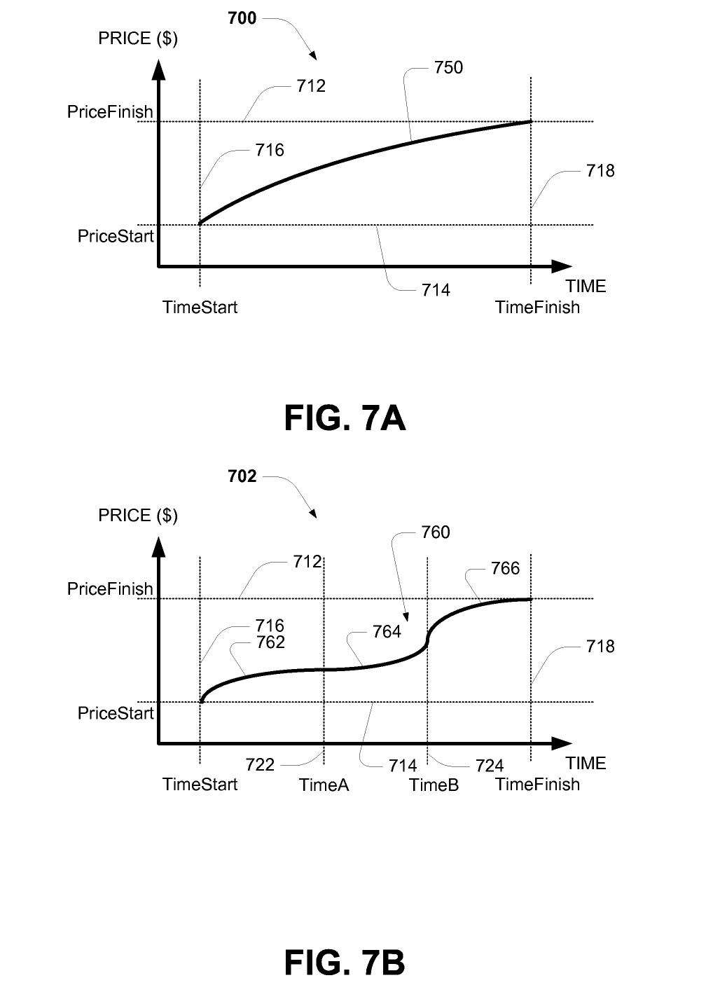

FIG. 7A shows an example pricing function 700. A finish price 712 typically being a recommended retail price, and a start price 714 typically being a predetermined percentage of the final price or a predetermined percentage of cost price. A start time 716 can be normalised to zero, and a finish time 718 can be set as the estimated availability of the product. In this example, the pricing function is a non-linear function 750 commencing from a start price at a start time and extending through to the finish price (recommended retail price) at the finish time (estimated availability of the product).

FIG. 7B shows an example pricing function 702. In this example, the pricing function is a piecewise non-linear function 760, with linear segments (762, 764, 766) defined between start time 716, Time-A 722 Time-B 724 and finish time 718. It will be appreciated that the pricing function commences from a start price at a start time and extending through to the finish price (recommended retail price) at the finish time (estimated availability of the product). By way of example, the location of Time-A and Time-B can be predetermined, a result of a manufacturing state or milestone, or a result of a sale milestone.

In an embodiment, by way of example only, dynamic pricing (PriceDynamic) can be computed using the following parameterised function of time (t) (wherein time is normalised such that the TimeStart=0). In this example, the function includes variables associated with a plurality of retail parameters, as set out below:

| | |
|---|---|
| PriceStart | Predetermined start price at TimeStart |
| PriceFinish | Predetermined retail price at TimeFinish |
| TimeStart | Duration of live pricing in days |
| TimeFinish | Duration of live pricing in days |
| TimeDuration | Duration of live pricing in days (Timestart − TimeFinish) |
| UnitsBatch | Number of units in a batch |
| UnitsSold | Number of units sold |
| UnitsExp | Exponent used in respect of units |
| FnSlope | Function slope parameter |
| FnSkew | Function skew parameter |

In this example embodiment, the LivePrice(t) is defined by a second order function F_logistic (t) and a linear correction function F_correct (t), as set out below.

LivePrice(t)=F_logistic(t)+F_correct(t)

The second order function can be expressed as:

F_logistic(t)=PriceStart+D×FactorSold+D×(1−FactorSold)/(1+exp(FnSlope(FnSkew−t/TimeDuration))),

where:

D=PriceFinish−PriceStart FactorSold=(UnitsSold/UnitsBatch)̂UnitsExp

The correction function is applied as a linear function over the TimeDuration period of the function from:

F_correct(t)=(B−A)*t/TimeDuration+A,

where:

A=PriceStart+DFactorSold−F_logistic(0) and

B=PriceFinish−F_logistic(TimeDuration)

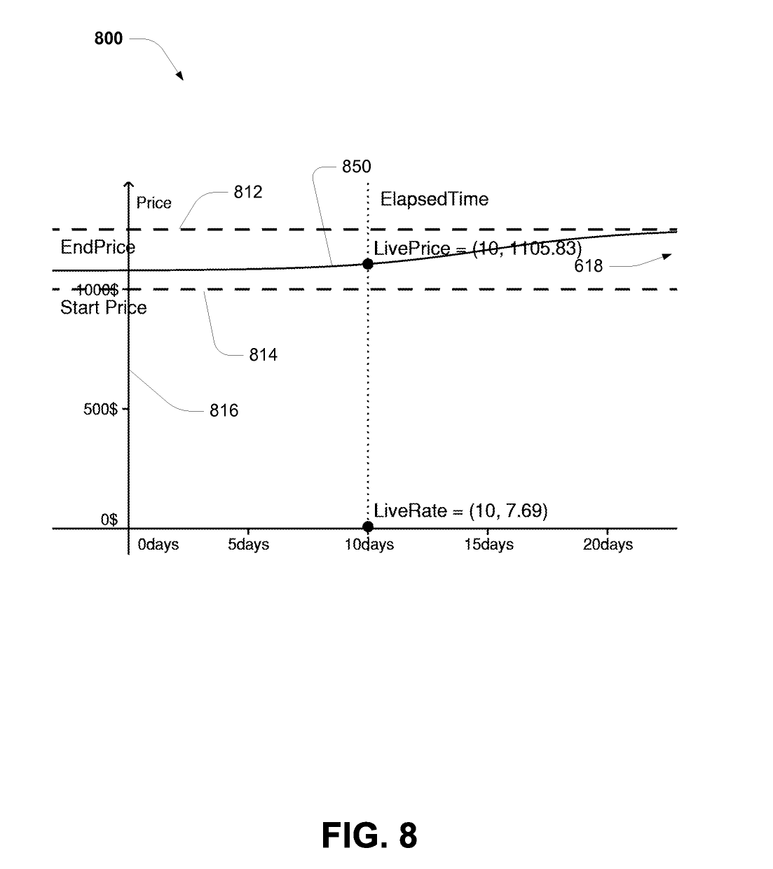

FIG. 8 shows a graph 800 of a dynamic pricing function curve 850 defined by LivePrice (t), wherein time is normalised such that the TimeStart=0 (816) and

TimeFinish is the estimated availability of the product, and wherein the variable parameters are set as follows:

| PriceFinish | $1250 | | (812) |
|---|---|---|---|
| PriceStart | $1000 | | (814) |
| TimeDuration | 30 | Days | |
| UnitsBatch | 100 | units | |
| UnitsSold | 10 | units sold | |

| | |
|---|---|
| UnitsExp | 0.5 |
| FnSlope | 10 |
| FnSkew | 0.5 |

In an alternative embodiment, by way of example only, dynamic pricing (PriceDynamic) can be computed using the following parameterised function of time (t) (wherein time is normalised such that the TimeStart=0).

A “Potency Factor” of percentage sold field can be included, whereby it can be adjusted whether, hypothetically, selling 99% of products on by a first time will increase or decrease toward the end price.

In this example, the function includes variables associated with a plurality of retail parameters, as set out below:

| | |
|---|---|
| TimeDuration | Duration of live pricing in days—fixed at start |
| PriceStart | Predetermined start price at TimeStart—fixed at start |
| PriceFinish | Predetermined retail price at TimeFinish—fixed at start |
| UnitsBatch | Number of units in a batch |
| UnitsSold | Number of units sold from the batch, which will |
| | change as the batch sells over time |
| SoldPercentExp | Adjusts how a SoldPercentFactor varies as units are |
| | sold |
| SoldPotency | Adjusts influence the Sold Percent can have—[0, 1] |
| FnSlope | Define gradient of a middle section of the func- |
| | tion—likely fixed at start |
| FnSkew | Skews the graph, which make maintain a lower price |
| | for longer - f many sales are required sooner or |
| | otherwise. - ikely fixed at start. |

Derived Variables can be specified as follows:

$$Diff = PriceFinish - PriceStart$$

$$SoldPercentFactor = SoldPotency \times {( \frac{UnitsSold}{UnitsBatch} )}^{SoldPercentageExp}$$

It will be appreciated SoldPercentFacor can scale the algorithm when units are sold. The basis of the price function can be expressed according to the following equation:

$$F\_logistic ( t ) = PriceStart + Diff \times SoldPercent + [ \frac{( 1 - SoldPercent ) \times Diff}{1 + {e}^{( FnSlope \times ( FnSkew - \frac{t}{TimeDuration} ) )}} ]$$

Further correction factors can be used to maintain the selected PriceStart and PriceFinish, as set out below.

Correction function ‘c’ is indicative of the distance F_logistic is from the PriceStart, while taking SoldPercent into account. This is to ensure that when the item starts on sale, the graph will intersect PriceStart.

c=PriceStart+Diff×SoldPercent−Fn_Logistic(0)

Correction function ‘d’ is indicative of the distance F_logistic is from PriceFinish, for maintaining an intersection at PriceFinish.

d=PriceFinish−F_logistic(Duration)

A linear correction function F_correct (t) can be used to remove bias applied by correction function ‘c’ and correction function ‘d’

$$F\_correct ( t ) = \frac{t ( d - c )}{Duration} + c$$

A LivePrice (t) can then be calculated based on F_logistic (t) and F_correct (t) as follows:

LivePrice(t)=F_logistic(t)+F_correct(t)

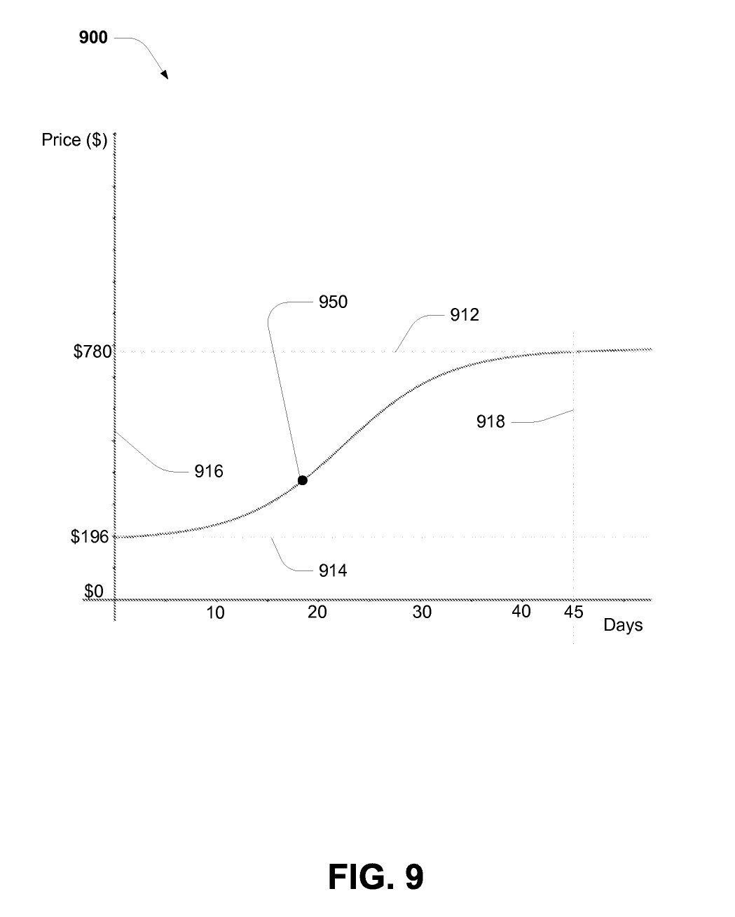

FIG. 9 shows a graph 900 of a dynamic pricing function curve 950 defined by the above LivePrice (t), wherein time is normalised such that the TimeStart=0 days (916) and TimeFinish=45 days (918) is the estimated availability of the product, and wherein the variable parameters are set as follows:

| PriceFinish | $780 | | (912) |
|---|---|---|---|
| PriceStart | $196 | | (814) |
| TimeDuration | 45 | Days | |
| UnitsBatch | 100 | units | |
| UnitsSold | 0 | units sold | |

| | |
|---|---|
| UnitsExp | 0.5 |
| FnSlope | 9 |
| FnSkew | 0.5 |
| SoldPotency | 0.5 |

As previously disclosed, the price function can indicate a decreasing price, as a function of time units. In an embodiment, when selling clearance items the dynamic price may be shown to decrease, but provided that limited stock is remaining, a stock count can also be shown to decrease over time for encouraging a prospective customer to purchase a good. For example, the above described dynamic pricing function curves LivePrice (t) can be configured to decrease as a function of the time units by setting a PriceStart higher than the PriceFinish

In an embodiment, the rate of decrease in dynamic price can be governed by any one or more of the following quantifiable parameters: the number of stock remaining, the duration of the clearance, the rate of good sold. It will be appreciated that the cost function can have localised increases due to these parameters.

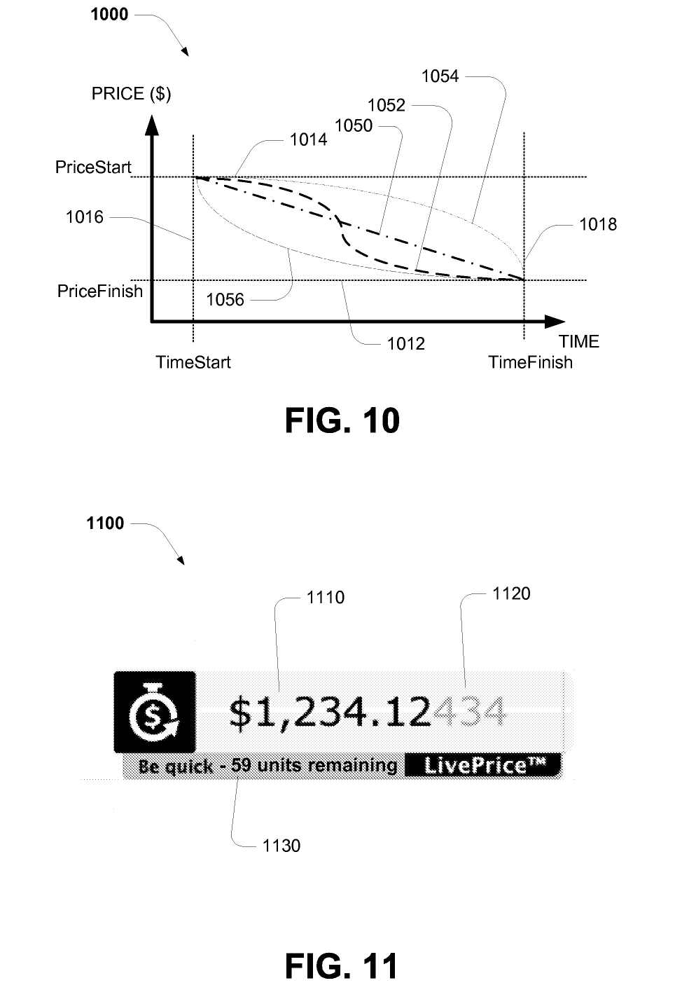

FIG. 10 shows example decreasing pricing functions 1000. A finish price 612 typically being a final clearance price or a predetermined percentage of cost price, and a start price 614 typically being a predetermined percentage of the recommended retail price, or a predetermined percentage of cost price. A start time 1016 can be normalised to zero, and a finish time 1018 can be set as the estimated availability of the product. By way of example, the pricing function can be a linear function 1050 (or alternatively a nonlinear function 1052, 1054, or 1056) commencing from a start price at a start time and extending through to the finish price at the finish time.

Referring to FIG. 11, a presented decreasing dynamic pricing can be in the form 1100. In this embodiment a dynamic price 1110 is optionally shown with additional fractional currency units 1120. A stock counter term 1130 may also be displayed to further highlight available of the clearance product. In this example, a clearance stock where price is decreasing, a prospective customer is enticed to purchase before stock can sell out. An advantages of a decreasing dynamic price, can assist stock being sold, but also retains urgency of purchase in a prospective customer's mind through the risk of a sell-out.

It will be appreciated that the illustrated apparatus and method for providing a dynamic online price for a commodity.

Further advantages of the embodiments disclosed can include any one or more of the following:
enabling receiving of money early in the supply chain or in advance of provision of goods or services;
users/customers are automatically provided a lower price for agreeing to wait for availability or entitlement;
adaptable method for any industry, wherein a live price starts at a low price (typically a percentage of manufacturing costs) and progresses to a recommended retail upon the expected delivery date or entitlement period;
the live price can factor any one or more of: recommended retail price, units sold, manufacturing batch size, unit availability, manufacturing status, delivery status;
reduces retailer inventory risk by pre-selling items;
creates negative cash-flow conversion cycle;
reduces the requirement for retailers and/or wholesalers to obtain finance;
provide access to funds for manufacture costs, by sourcing it from customers;
encouraging pre-purchase of goods or services; and
encouraging sale of clearance stock.

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Similarly, it is to be noticed that the term “coupled”, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. An apparatus for presenting a dynamic pricing of a commodity to a prospective client, the apparatus comprising:
a server module coupleable to a database that includes data indicative of pricing parameters for calculating the dynamic pricing; the server module being coupleable by a data network to a remote interface element for presenting the dynamic pricing to the prospective client; and
the apparatus being adapted to:
(a) receive pricing parameters for calculating the dynamic pricing;
(b) compute the dynamic pricing according to a predetermined pricing function using the pricing parameters; and
(c) present an instant of the dynamic pricing to the prospective client.

2. The apparatus according to claim 1, wherein the dynamic pricing is calculated in substantially real-time using current pricing parameters.

3. The apparatus according to claim 2, wherein the presented dynamic pricing is repeatedly updated.

4. The apparatus according to claim 3, wherein the presented dynamic pricing is repeatedly updated on a periodic basis using real-time prising parameters.

5. The apparatus according to claim 4, wherein the server module presents a user interface comprising the dynamic pricing to the prospective client.

6. The apparatus according to claim 5, wherein user interface can enable the prospective client to agree to purchase the commodity for the price indicated by the presented dynamic pricing.

7. The apparatus according to claim 6, wherein the user interface enables the prospective client to attend to payment of the commodity for the price indicated by the presented dynamic pricing.

8. The apparatus according to claim 5, wherein the pricing function is a function of time periods.

9. The apparatus according to claim 8, wherein the pricing function is monotonically non-decreasing as a function of the time units.

10. The apparatus according to claim 8, wherein the pricing function is monotonically increasing as a function of the time units.

11. The apparatus according to claim 8, wherein the pricing function is a piecewise linear function.

12. The apparatus according to claim 8, wherein the pricing parameters include parameters indicative of any one or more of the set comprising: manufacturing status; availability status; and pre-sold status.

13. The apparatus according to claim 12, wherein the pricing parameters further include parameters indicative of any one or more of the set comprising: a predetermined constant parameter; duration of dynamic pricing in time units; start price at commencement of dynamic pricing; finish price being a final retail price at the conclusion of dynamic pricing; duration of live pricing in time periods; number of units in a batch; number of units currently sold from the batch; and rate of sales.

14. The apparatus according to claim 13, wherein the commodity is offered for sale prior to availability, and the pricing function increases from start price at commencement of dynamic pricing to a finish price being a final retail price about the time when the commodity becomes available.

15. A method of providing a dynamic pricing for a commodity, the method comprising the steps of:
(a) receiving pricing parameters for calculating the dynamic pricing;
(b) computing the dynamic pricing according to a predetermined pricing function using the pricing parameters; and
(c) presenting an instant of the dynamic pricing.

16. The method according to claim 15, wherein the dynamic pricing is calculated in substantially real-time using current pricing parameters.

17. The method according to claim 16, the method further comprising the step of: repeatedly updating the dynamic pricing presented to the prospective client.

18. The method according to claim 17, wherein the presented dynamic pricing is repeatedly updated on a periodic basis using real-time prising parameters.

19. The method according to claim 18, the method further comprising the step of: presenting a user interface comprising the dynamic pricing to the prospective client.

20. The method according to claim 15, the method further comprising the step of: presenting an apparatus comprising a server module coupleable to a database that includes data indicative of the pricing parameters for calculating the dynamic pricing; and the server module being coupleable by a data network to a remote interface element for presenting the dynamic pricing to the prospective client.
